(19) United States
(12) Patent Application Publication
(10) Pub. No.: US 2008/0292880 A1
(43) Pub. Date: Nov. 27, 2008

(54) INSULATING FACING TAPE AND PROCESS TO MAKE SAME

(75) Inventor: Anne Hansen, North Reading, MA (US)

Correspondence Address: FISH & RICHARDSON P.C., P.O BOX 1022, Minneapolis, MN, 55440-1022, US

(73) Assignee: American Biltrite, Inc., Wellesley Hills, MA (US)

(21) Appl. No.: 11/752,071

(22) Filed: May 22, 2007

(51) Int. Cl. B32B 7/12; B05D 5/10

(52) U.S. Cl. 428/356; 427/208.4

(57) ABSTRACT

An insulating facing tape material that can be used for covering exposed insulation surfaces to protect them from moisture and other environmental factors. The material typically includes a first layer of metal-containing foil, a second layer of metal-containing foil, a polymeric layer that is disposed between the first and second layers of metal-containing foil, and a pressure-sensitive adhesive connected to one of the layers of metal-containing foil and exposable for securing the tape material to a substrate. The polymeric layer is a laminate of multiple sub-layers of different principal polymer orientations. The pressure-sensitive adhesive layer may be covered with a release liner prior to application.

### TECHNICAL FIELD

This invention relates to an insulating facing tape material, and more particularly to an insulating facing tape that can be used for covering exposed insulation surfaces to protect them from moisture and other environmental factors.

### BACKGROUND

In domestic, commercial, and industrial buildings, pipes, duct work, and other conduits are utilized in heating and cooling systems. Typically in such systems, these conduits transport gases or liquids (i.e., heated or cooled air, steam, etc.). Furthermore, in some environments, systems are present in which other gases or liquids (i.e., chemicals or petroleum products) are transported through such conduits. Generally such conduits are insulated, particularly if the conduits are exposed to outside environmental factors (moisture, heat, etc.).

When such conduits are exposed to environmental factors, the conduit is prone to degrade. Accordingly, it is common, under such circumstances, to utilize a facing to cover the conduit and its insulation. Such facings include metal cladding, butyl rubber, thin layers of aluminum foil, scrim and mastics, and bitumen felt and netting.

Another such facing includes the use of pressure-sensitive tapes. When, for example, an insulation jacket is applied to a pipe to reduce the transfer of heat, the insulation jacket typically comes in two pieces that surround the pipe. The longitudinal gap must be sealed, such as by pressure-sensitive tapes. Moreover, when two insulating jackets abut one another, this gap too must be sealed. Pressure-sensitive tapes have been used for such sealing, including pressure-sensitive tapes that comprise layers of aluminum foil and polymers, as well as an adhesive layer and release layer. Such pressure-sensitive tapes are disclosed in U.S. Pat. No. 5,736,211, issued Apr. 7, 1998, to Fontanilla and U.S. Pat. No. 6,953,512, issued Oct. 11, 2005, to Cohen et al.

Such pressure-sensitive tapes are relatively inexpensive, generally easy to apply, and provide a good appearance. Nonetheless, and particularly for use in extreme conditions, the effectiveness, durability, and life expectancy of these facing tapes remain an issue. For instance, there exists a need for better adhesion, strength, puncture resistance, robustness, and resistance to water/vapor infiltration of such facing tapes.

### SUMMARY

In one aspect of the invention, an insulating facing tape includes a first layer of metal-containing foil having a first side and second side, and a second layer of metal-containing foil having a first side and a second side. The first side of the first layer of metal-containing foil and the first side of the second layer of metal-containing foil face one another and form a space therebetween. A polymeric layer is disposed in the space between the first and second layers of metal-containing foil. A pressure-sensitive adhesive is connected to second side of the second layer of metal-containing foil. The pressure-sensitive adhesive is exposable for securing the insulating facing tape to a substrate.

In some embodiments, one or more of the sub-layers of the polymeric layer comprise polyethylene. The first layer of metal-containing foil and the second layer of metal-containing foil are substantially the same type of metal-containing foil. The first layer of metal-containing foil may be aluminum foil. The first layer of metal-containing foil has a thickness between about 0.0005 inches and about 0.0010 inches. The second layer of metal-containing foil has a thickness between about 0.0005 inches and about 0.0010 inches. A thickness of the first layer of metal-containing foil may be at least as thick as a thickness of the second layer of metal-containing foil.

In some embodiments, the number of sub-layers is at most eight. A thickness of the polymeric layer is between about 0.0025 inches and about 0.0065 inches. Each sub-layer of the polymeric material may be made of substantially the same material. In some embodiments, at least one of the sub-layers of the polymeric layer is made from a first polymeric material and at least one of the sub-layers of the polymeric layer is made from a second polymeric material.

In some embodiments, the pressure-sensitive adhesive includes a mold inhibitor. Tear resistance of the insulating facing tape is between about 15 lbs and 20 lbs per ASTM 4533. In some embodiments, the first layer of metal-containing foil has a thickness between about 0.0005 inches and about 0.0010 inches, the second layer of metal-containing foil has a thickness between about 0.0005 inches and about 0.0010 inches, the polymeric layer has a thickness between about 0.0025 inches and about 0.0065 inches, and at least one sub-layer of the polymeric layer includes polyethylene.

In another aspect of the invention, a method of making an insulating facing tape includes selecting a first layer of metal-containing foil having a first side and a second side, selecting a second layer of metal-containing foil having a first side and a second side, forming a polymeric layer between the first side of the first metal-containing foil and the first side of the second metal containing foil, and applying a pressure-sensitive adhesive to the second side of the second layer of metal-containing foil. The forming step includes comprises cross laminating two or more sub-layers with different principal polymer orientations. The pressure-sensitive adhesive is exposable for securing the insulation facing tape to a substrate.

In some embodiments, the forming step include cross laminating four sub-layers with different principal polymer orientations. At least two of the four sub-layers may have different principal polymer orientations. The forming step may include cross laminating up to eight sub-layers with different principal polymer orientations. At least two of the eight sub-layers may have different principal polymer orientations. In some embodiments, the method includes covering the pressure-sensitive adhesive with a release liner.

As a laminate of multiple sub-layers of different principal polymer orientations, the insulating facing tape described herein provides strength, puncture resistance, and stiffness in multiple-directions, thus enhancing the effectiveness, durability, and life expectancy characteristics of the tape.

The detail of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a cross-sectional view of an embodiment of insulating facing tape.

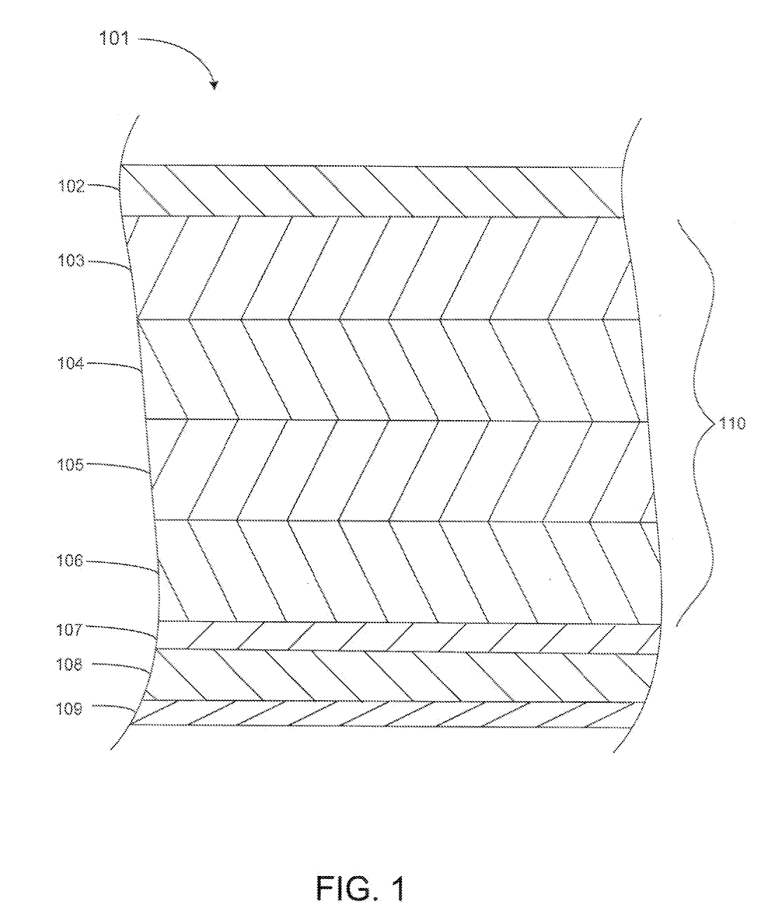

With reference now to FIG. 1, this figure shows a cross-sectional view of an embodiment of insulating facing tape. Insulating facing tape 101 includes a first layer of metal-containing foil 102, a second layer of metal-containing foil 107, a polymeric layer 110 disposed between the first and second layers of metal-containing foil 102 and 107, and a pressure-sensitive adhesive 108, connected to metal-containing foil 107 and exposable for securing the tape material 101 to a substrate (not shown). The pressure-sensitive adhesive layer 108 may be covered with a release liner 109 which may be removed prior to application.

The metal-containing foil 102 may be a metalized foil or a metal foil. For instance, metal-containing foil 102 may be an aluminum foil (available from Norandal, JW Aluminum, Alcoa, and others), a copper foil, a stainless-steel foil, and/or a titanium foil. Metalized foils that can be useful in the present invention for one or both of metal-containing foils 102 and 107 include commercially available foils in which metal, such a aluminum, copper, steel, titanium, etc., has been deposited on a substrate.

The metal-containing foil 107 may include the same type of metal as the metal-containing foil 102. For instance, when metal-containing foil 102 is an aluminum foil, metal-containing foil 107 may be an aluminum foil or an aluminized foil. A thickness of the metal-containing foil 102 may be the same as or different than a thickness of the metal-containing foil 107. In some embodiments, a thickness of the metal containing foil 102 is about the same or thicker than a thickness of the metal containing foil 107.

Generally, at least one of the metal-containing foils 102, 107 is a metal foil, as metalized foils can have tiny holes in them that occur during manufacture of the metalized foils. In some embodiments, the metal-containing foil 102 is a metal foil.

In some embodiments, a thickness of the metal-containing foil 102 is between about 0.0005 inches and about 0.0010 inches, and a thickness of the metal-containing foil 107 is between about 0.0005 inches and about 0.0010 inches. For instance, both metal-containing foil 102 and metal-containing foil 107 may be an aluminum foil with a thickness of about 0.0007 inches.

The polymeric layer 110 a laminate of multiple sub-layers (103-106) of different principal polymer orientations. One or more of sub-layers 103-106 may include polyethylene. Polymeric layer 110 includes at least 2 sub-layers, from 2 to 8 sub-layers, or more than 8 sub-layers. An overall thickness of the polymeric layer 110 is between about 0.0025 inches and about 0.0065 inches. For instance, an overall thickness of the polymeric layer 110 may be about 0.0040 inches.

The sub-layer 103 proximate metal-containing foil 102 and the sub-layer 106 proximate metal-containing foil 107 may be similar or substantially the same. In some embodiments, the sub-layer 103 and the sub-layer 106 are mirror images of one another, with substantially the same thickness and polymer orientation.

The sub-layers 103-106 may include polyethylene (such as manufactured by Valeron Strength Films; Houston, Tex.). This oriented and cross-laminated polyethylene film provides desirable strength, elongation, and barrier characteristics.

The sub-layers 103-106 are laminated to the metal-containing foil 102, 107 by standard laminating techniques. To further strengthen the bond between the sub-layers 103, 106 and the metal containing foil 102, 107, an adhesive may be applied to the surface of the sub-layers 103, 106. The adhesive may include a two-component polyester urethane or expoxy system.

As used herein, “pressure-sensitive adhesive” means an adhesive that will adhere to a variety of dissimilar surfaces upon mere contact without the need of more than finger or hand pressure. Pressure-sensitive adhesives are sufficiently cohesive and elastic in nature so that, despite their aggressive tackiness, they can be handled with the fingers and repositioned on smooth surfaces with little or no residue left behind. Pressure-sensitive adhesives can be quantitatively described using the “Dahlquist criteria,” which maintains that the elastic modulus of these materials is less than 10⁶ dynes/cm² at room temperature. [See Pocius, A. V., Adhesion & Adhesives: An Introduction, Hanser Publications, New York, N.Y., First Edition, 1997]

The pressure-sensitive adhesive layer 108 may be an acrylic adhesive that is pressure-sensitive for bonding to various materials (such as metals) under extreme conditions (such as wide temperature variations and high moisture content) and provides excellent chemical resistance and good adhesive properties over the long term. The pressure adhesive layer should be capable of remaining tacky and useable at temperature between about 10° F. and about 250° F. Examples of suitable acrylic polymers include Aroset 1845 (obtainable from Ashland Chemical Company, Columbus, Ohio) or DEV-8618T (obtainable from Avery Dennison Performance Polymers, Mill Hall, Pa.). Such adhesive meets the Dahlquist criteria. In some cases, the pressure-sensitive adhesion layer 108 includes a mold inhibitor mixed with the adhesive. The mold inhibitor may include silver particles, silver paste, or other forms of silver. The mold inhibitor may include Ciba Irgaguard B5000.

A thickness of the pressure-sensitive adhesion layer 108 may range from about 0.0016 inches to about 0.0024 inches. For instance, a thickness of the pressure-sensitive adhesion layer 108 may be about 0.0020 inches.

The liner 109 may be natural kraft paper. The kraft paper may be coated with a silicon, such as Loparex 27384. A thickness of the liner 109 maybe between about 0.0030 inches, and about 0.0080 inches. For instance, a thickness of the liner 109 may be about 0.0050 inches.

In some embodiments, an overall thickness of insulating facing tape 101 is between about 0.010 inches and about 0.020 inches. For instance, an overall thickness may be about 0.015 inches.

In some embodiments, a tear resistance of insulating facing tape 101 is between about 16 and about 22 lbs., as measured using the trapezoid tear method described in ASTM standard D 4533.

### EXAMPLE 1

The foil-film-foil lamination is created through a standard lamination process. An adhesive, such as a two-component polyester urethane or expoxy system is applied to one layer or foil or film with a gravure roll/rubber roll coating nip. The coated web is transported through a drying oven to remove solvent and begin the curing of the adhesive. The web is then laminated to the other layers at a laminating nip with a steel roll/rubber roll combination.

Four sub-layers of cross laminated polyethylene were laminated between two layers of aluminum foil, each with a thickness of about 0.0007 inches. The cross-lamination was obtained by first producing a polyethylene film using the blown film extrusion process. The flattened tube from this process was converted by spiral cutters into two piles cut at a 45° angle from the original machine direction. In another step these individual layers are laminated together by extrusion lamination. The sub-layers included polyethylene (manufactured by Valeron Strength Films; Houston, Tex.). The total thickness of the sub-layer was around 0.0040 inches after cross-lamination of the sub-layers. An angle between the orientation of the aluminum foils and the four sub-layers was about 45°.

The pressure-sensitive adhesive utilized was Avery DEV-8618T. A mold inhibitor, (Ciba Irgaguard B5000) was added to the pressure sensitive adhesive. The pressure-sensitive adhesive had a thickness of about 0.0020 inches. The liner had a thickness of about 0.0050 inches. The overall thickness of the insulating facing tape was about 0.0150 inches.

The puncture resistance of the insulating facing tape of Example 1 was tested using ASTM D4533. The trapezoid tearing strength of this facing tape was found to be about 19 lbs. Other facing tapes were tested with results of about 3 lbs. As shown in these results, for facing tapes of comparable thickness, the present invention has superior tear resistance. Moreover, the flexibility and strength characteristics of the insulating facing tape made in Example 1 is improved over the other compared products.

Adhesion of the insulating facing tape of Example 1 was tested at a variety of temperatures. Adhesion to steel using PSTC Method 1 is between about 40 lb/inch width and about 50 lb/inch width at temperatures of 70° F., 40° F. and 0° F.

It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. Insulation facing tape constructed as a strip-form, flexible laminate structure comprising:
(a) a first layer of metal-containing foil having a first side and a second side;
(b) a second layer of metal-containing foil having a first side and a second side, wherein the first side of the first layer of metal containing foil and the first side of the second layer of metal containing foil face one another and form a space therebetween;
(c) a polymeric layer that is disposed in the space between the first and second layers of metal-containing foil, wherein the polymeric layer is a laminate of two or more sub-layers of different principal polymer orientations; and
(d) a pressure-sensitive adhesive connected to the second side of the second layer of metal-containing foil, wherein the pressure-sensitive adhesive is exposable for securing the insulation facing tape to a substrate.

2. The insulating facing tape of claim 1, wherein one or more of the sub-layers of the polymeric layer comprise polyethylene.

3. The insulating facing tape of claim 1, wherein the first layer of metal-containing foil and the second layer of metal-containing foil are substantially the same type of metal containing foil.

4. The insulating facing tape of claim 1, wherein the first layer of metal-containing foil is aluminum foil.

5. The insulating facing tape of claim 1, wherein the first layer of metal-containing foil has a thickness between about 0.0005 inches and about 0.0010 inches.

6. The insulating facing tape of claim 5, wherein the second layer of metal-containing foil has a thickness between about 0.0005 inches and about 0.0010 inches.

7. The insulating facing tape of claim 1, wherein the first layer of metal-containing foil has a thickness and the second layer of metal-containing foil has a thickness, wherein the thickness of the first layer of metal-containing foil is at least as thick as the thickness of the second layer of metal-containing foil.

8. The insulating facing tape of claim 1, wherein the number of sub-layers is at most eight.

9. The insulating facing tape of claim 1, wherein a thickness of the polymeric layer is between about 0.0025 inches and about 0.0065 inches.

10. The insulating facing tape of claim 1, wherein each sub-layer of the polymeric layer is made of substantially the same material.

11. The insulating facing tape of claim 1, wherein some of the sub-layers of the polymeric layer are made from a first polymer material and some of the sub-layers of the polymeric layer are made from a second polymer material.

12. The insulating facing tape of claim 1, wherein the pressure-sensitive adhesive comprises a mold inhibitor.

13. The insulating facing tape of claim 1, wherein tear resistance of the insulating facing tape is between about 15 lbs and about 20 lbs per ASTM D4533.

14. The insulating facing tape of claim 1, wherein
(a) the first layer of metal-containing foil has a thickness between about 0.0005 inches and about 0.0010 inches;
(b) the second layer of metal-containing foil has a thickness between about 0.0005 inches and about 0.0010 inches;
(c) the polymeric layer has a thickness between about 0.0025 inches and about 0.0065 inches; and
(d) at least one sub-layer of the polymeric layer comprises polyethylene.

15. A method of making an insulating facing tape comprising:
(a) selecting a first layer of metal-containing foil having a first side and a second side;
(b) selecting a second layer of metal-containing foil having a first side and a second side;
(c) forming a polymeric layer between the first side of the first metal-containing foil and the first side of the second metal containing foil, wherein said forming step comprises cross laminating two or more sub-layers with different principal polymer orientations; and
(d) applying a pressure-sensitive adhesive to the second side of the second layer of metal-containing foil, wherein the pressure-sensitive adhesive is exposable for securing the insulation facing tape to a substrate.

16. The method of claim 15, wherein said forming step comprises cross laminating four sub-layers with different principal polymer orientations.

17. The method of claim 15, wherein said forming step comprises cross laminating four sub-layers, wherein at least two of the sub-layers have different principal polymer orientations.

18. The method of claim 15, wherein said forming step comprises cross laminating up to eight sub-layers with different principal polymer orientations.

19. The method of claim 15, wherein said forming step comprises cross laminating up to eight sub-layers, wherein at least two of the sub-layers have different principal polymer orientations.

20. The method of claim 15 further comprising covering the pressure-sensitive adhesive with a release liner.
